(19) United States
(12) Patent Application Publication
(10) Pub. No.: US 2015/0046164 A1
(43) Pub. Date: Feb. 12, 2015

(54) METHOD, APPARATUS, AND RECORDING MEDIUM FOR TEXT-TO-SPEECH CONVERSION

(71) Applicant: Samsung Electronics Co., Ltd., Gyeonggi-do (KR)

(72) Inventor: Hari Krishna Maganti, Middlesex (GB)

(21) Appl. No.: 14/454,520

(22) Filed: Aug. 7, 2014

(30) Foreign Application Priority Data
Aug. 7, 2013 (GB) 1314175.9
Jun. 30, 2014 (KR) 10-2014-0080753

(51) Int. Cl. G10L 13/04

(52) U.S. Cl. CPC G10L 13/043
USPC 704/260

(57) ABSTRACT

A text-to-speech conversion method includes receiving a message including text and originator identification information, retrieving stored voice data corresponding to an originator identified by the originator identification information, and synthesizing speech from the text included in the message based on the retrieved voice data. A text-to-speech conversion apparatus is also disclosed, where the voice data can be updated using a voice signal obtained during a telephone conversation including the originator. The speech can be synthesized using a statistical parametric speech synthesis method, and the voice data can include a statistical acoustic voice model. The speech can also be synthesized according to an emotion detected from the text in the received message.

### CROSS-REFERENCE TO RELATED APPLICATIONS AND CLAIM OF PRIORITY

The present application is related to and claims the priority under 35 U.S.C. §119(a) to United Kingdom Application Serial No. 1314175.9, which was filed in the United Kingdom Intellectual Property Office on Aug. 7, 2013, and Korean Application Serial No. 10-2014-0080753, which was filed in the Korean Intellectual Property Office on Jun. 30, 2014, the entire content of which are hereby incorporated by reference.

### TECHNICAL FIELD

The present disclosure relates to a method, an apparatus, and a recording medium for text-to-speech conversion, which synthesize speech from text using voice data for a particular individual.

### BACKGROUND

In recent years, communication devices such as smartphones, tablet PCs, and the like have been developed which are able to read out text from a received message in a predefined voice. However, this approach results in speech output that is monotonous and lacking spontaneity, and which may be difficult to understand for users in different geographical regions who are accustomed to different accents to that of the predefined voice. It would be more helpful for the user to listen to the text in a natural voice, for example, one with which they are more familiar.

The present disclosure is made in this context.

### SUMMARY

To address the above-discussed deficiencies, it is a primary object to provide a method, an apparatus, and a recording medium for TTS (Text-to-Speech) conversion, which analyze and store the characteristics of voice of the counterpart during a telephone conversation so that, when a SMS message, an e-mail, an IM message, or a SNS message is received from the counterpart, the stored characteristics of voice of the counterpart are used to perform TTS conversion and reproduction.

It is another aspect of the present disclosure to provide a method, an apparatus, and a recording medium for TTS conversion which, during TTS conversion of the SMS message, e-mail, IM message, or SNS message and following reproduction, extract preset emotion information corresponding to an emoticon and a specific word (e.g. “Congratulations”) and perform TTS conversion and reproduction.

According to an aspect of the present disclosure, there is provided a text-to-speech (TTS) conversion method including receiving a message including text and originator identification information, retrieving stored voice data corresponding to an originator identified by the originator identification information, and synthesizing speech from the text included in the message based on the retrieved voice data.

The method may further include obtaining a first voice signal transmitted by the originator during a telephone conversation, obtaining a textual representation of speech included in the first voice signal, using an automatic speech recognition method, and updating the stored voice data using the first voice signal and the obtained textual representation.

The method may further include obtaining a plurality of first voice signals from a plurality of telephone conversations between the originator and one or more other originators and obtaining the textual representation, and the updating the stored voice data may be performed for each of the plurality of first voice signals.

The method may further include providing the originator with predetermined text, obtaining a second voice signal while the originator speaks the predetermined text, and updating the stored voice data using the second voice signal and the predetermined text.

The method may further include deleting at least one voice signal of the first or second voice signal after updating the stored voice data.

The voice data may include a statistical acoustic model, and the speech may be synthesized using a statistical parametric speech synthesis method.

The method may further include determining an emotion from the text included in the message, and the speech may be synthesized according to the determined emotion.

The emotion may be determined by performing at least one of detecting an emoticon included in the text and identifying an emotion corresponding to the detected emoticon, or analyzing the text using a natural language processing method.

The originator identification information may include at least one of a telephone number, an email address, or an originator name, and the message may include a Short Message Service (SMS) message, an email, an Instant Messaging (IM) message, or a Social Networking Service (SNS) message.

The message may be received by a communication device, the speech synthesis may be performed by a server configured to communicate with the communication device, and the method may further include: receiving the synthesized speech from the server by the communication device; and reproducing the synthesized speech by the communication device.

The message may be received by a communication device, and the retrieving the voice data and the synthesizing the speech may be performed by the communication device.

According to another aspect of the present disclosure, there is provided a computer-readable storage medium configured to store a computer program which performs the TTS conversion method when executed by a processor.

According to another aspect of the present disclosure, there is provided a text-to-speech conversion apparatus including a receiving module configured to receive a message including text and originator identification information, a voice data retrieving module configured to retrieve voice data corresponding to an originator identified by the originator identification information, from a storage unit, and a speech synthesis module configured to synthesize speech from the text included in the message based on the retrieved voice data.

The apparatus may further include a voice data management module configured to obtain a first voice signal transmitted by the originator during a telephone conversation, obtain a textual representation of speech included in the first voice signal, using an automatic speech recognition method, and update the stored voice data using the first voice signal and the obtained textual representation.

The voice data management module may be configured to obtain a plurality of first voice signals from a plurality of telephone conversations between the originator and one or more other originators, and to obtain a textual representation and update the stored voice data for each of the plurality of first voice signals.

The originator may be provided with predetermined text, and the voice data management module may be configured to obtain a second voice signal while the originator speaks the predetermined text, and update the stored voice data using the second voice signal and the predetermined text.

The voice data management module may be further configured to delete at least one of the first or second voice signal after updating the stored voice data.

The voice data may include a statistical acoustic model, and the speech synthesis module may be configured to synthesize the speech using a statistical parametric speech synthesis method.

The apparatus may further include an emotion analysis module configured to determine an emotion from the text included in the message, and the speech synthesis module may be configured to synthesize the speech according to the determined emotion.

The emotion analysis module may be configured to determine the emotion by performing at least one of detecting an emoticon included in the text and identifying an emotion corresponding to the detected emoticon, or analyzing the text using a natural language processing method.

The originator identification information may include at least one of a telephone number, an email address, or an originator name, and the message may include a Short Message Service (SMS) message, an email, an Instant Messaging (IM) message, or a Social Networking Service (SNS) message.

The receiving module may be included in a communication device, the speech synthesis module may be included in a server, and the communication device may be configured to communicate with the server, to receive the synthesized speech from the server, and to reproduce the synthesized speech.

According to another aspect of the present disclosure, the receiving module, the voice data retrieving module, and the speech synthesis module may all be included in a communication device.

As described above, a method, an apparatus, and a recording medium for TTS conversion according to an aspect of the present disclosure are used to analyze and store the characteristics of voice of the counterpart during a telephone conversation so that, when a SMS message, an e-mail, an IM message, or a SNS message is received from the counterpart, the stored characteristics of voice of the counterpart are used to perform TTS conversion and reproduction. In addition, during TTS conversion of the SMS message, e-mail, IM message, or SNS message and following reproduction, preset emotion information corresponding to an emoticon and a specific word (e.g. “Congratulations”) is extracted to perform TTS conversion and reproduction.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a text-to-speech conversion method using stored voice data, according to an embodiment of the present disclosure;

FIG. 2 illustrates a method of updating the stored voice data, according to an embodiment of the present disclosure;

FIG. 3 illustrates a method of updating the stored voice data, according to an embodiment of the present disclosure;

FIG. 4 illustrates a method of performing remote speech synthesis at a server using text from a message received by a communication device, according to an embodiment of the present disclosure;

FIG. 5 illustrates a method of detecting emotion from a received message and synthesizing speech according to the detected emotion, according to an embodiment of the present disclosure;

FIG. 6 illustrates a text to speech conversion apparatus, according to an embodiment of the present disclosure;

FIG. 7 illustrates a communication device configured to convert text in a received message into speech, according to an embodiment of the present disclosure; and

FIG. 8 illustrates a communication device configured to obtain synthesized speech from a server and a system including the server, according to an embodiment of the present disclosure.

### DETAILED DESCRIPTION

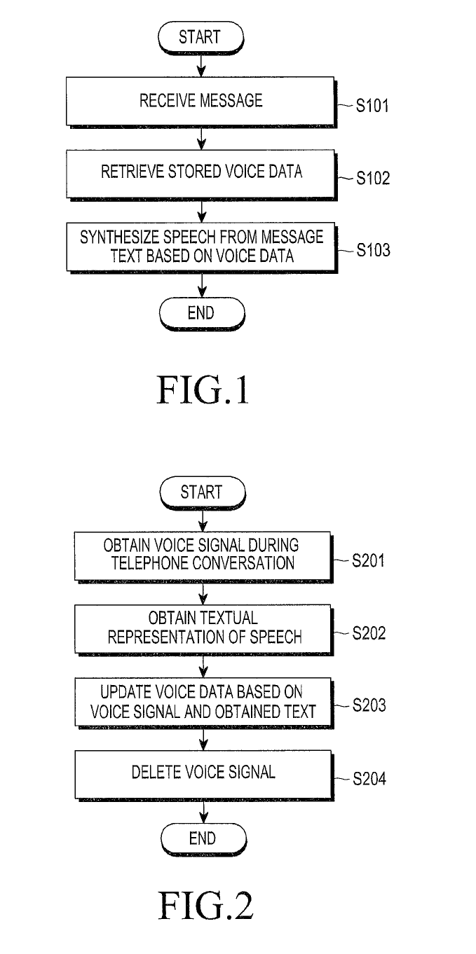

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. FIG. 1 illustrates a text-to-speech (TTS) conversion method according to an embodiment of the present disclosure. The TTS conversion method according to an embodiment of the present disclosure can be used to convert text from a received message into speech. The TTS conversion method according to an embodiment of the present disclosure can be applied to any type of text-based message including, without being limited to, Short Message Service (SMS) messages, Instant Messaging (IM) service messages, Social Networking Service (SNS) messages, and emails.

The received message can include originator identification information which identifies the originator of the message. For example, for an SMS message the originator identification information can be the telephone number from which the message was sent. For an IM service message or an SNS message, the originator identification information can be the originator account from which the message was sent, which can be identified by a unique identifier such as an originator name or account number. For an email, the originator identification information can be the email address from which the email was sent.

Referring to FIG. 1, a communication device (also referred to as a recipient) can receive a message including text and originator identification information in operation S101. The communication device can retrieve, in operation S102, stored voice data corresponding to an originator identified by the originator identification information of the received message. According to an embodiment, the stored voice data can be retrieved from local storage unit such as local hard disk drive or other type of non-volatile memory, or can be retrieved from a remote location such as an Internet server.

After retrieving stored voice data corresponding to the originator, the communication device can synthesize, in operation S103, speech from the text included in the message based on the retrieved voice data. The stored voice data corresponding to the originator can include voice data which has been adapted to the particular originator, from recorded voice signals featuring that originator's voice. By identifying the originator of the received message and synthesizing speech using the voice data which corresponds to the originator, the communication device is able to reproduce the text in the voice of the originator.

The voice data can have various forms. In an embodiment of the present disclosure, the speech can be synthesized using a statistical parametric speech synthesis method, and the voice data can be a statistical acoustic model which has been tailored to the particular originator. The statistical acoustic model can also be referred to as a voice model. Speech recordings can be used to train the parameters of the statistical acoustic model to individual originators, and the storage unit can store a separate model for each one of a plurality of originator.

The statistical parametric speech synthesis is a corpus independent and model-based technique, which is capable of rapid adaptation and requires a relatively small amount of training data. The basic model can be a Hidden Markov Model (HMM), or a closely related variant which can be referred to as a Hidden Semi-Markov Model (HSMM).

The voice model can be trained using a communication device (or a voice data management system), which uses recorded voice signals of the individual originator's speech along with a text record of the words being spoken in the voice signals. In addition, a voice signal and corresponding text can provide the communication device (or the voice data management system) with a string of phonemes and additional contextual information. The communication device (or voice data management system) can employ speaker adaptation to transform existing speaker-independent acoustic models to match a target speaker (e.g. originator) using a very small amount of speech data.

The speaker adaptation can be performed by starting an average voice model, and using model adaptation techniques drawn from speech recognition such as maximum likelihood linear regression (MLLR), to adapt the speaker independent HMMs to a new speaker (e.g. originator). For example, appropriate models can be used to select the most likely spectral values for each time frame, whilst ensuring a smoothly varying trajectory over the elapse of time. From these parameters, a speech waveform can be constructed using signal processing techniques. This process can be optimized to minimize the distortion between the synthesized speech and an equivalent real sample. The speaker adaptive HMM-based synthesis can require as little as 5-10 minutes of recorded speech from a target speaker in order to generate a personalized synthetic voice.

The HMM approach used in an embodiment of the present disclosure for speech synthesis is similar to an Automatic Speech Recognition (ASR) method. However, the HMMs used in the statistical parametric speech synthesis method according to an embodiment of the present disclosure are, rather than modelling triphone units, as in the ASR method, based on units with a much richer context, including not only more phonemes to the left and right, but additional features such as prosodic information. The use of the richer context means that most theoretically possible units will not be seen in the training data, so the units are automatically clustered during the training process, sharing parameters. This allows data to be shared between units, thereby making best use of the available data and meaning that less speech data is required to build a voice model. The parametric speech synthesis method can be suitable for use with speech of relatively low quality, such as can be obtained from mobile telephone conversations.

At the speaker adaptation stage in an embodiment of the present disclosure, the average voice model can be adapted to the target speaker using speaker adaptation techniques for multi-stream MSD-HSMM. Examples of speaker adaptation techniques can include maximum a posteriori (MAP), structural maximum a posteriori (SMAP), and constrained structural maximum a posteriori linear regression (CSMAPLR). It is described in an embodiment of the present disclosure that a combination of the CSMAPLR and MAP adaptation techniques is used, but in other embodiments other suitable techniques could be used.

Although one parametric speech synthesis method has been described above, embodiments of the present disclosure are not limited to the above-described particular method of generating and updating voice data for different originators. For example, in other embodiments different parametric speech synthesis methods can be used, or an exemplar-based method can be used instead. In the exemplar-based method, the voice data can include a plurality of short record speech samples of real speech utterances indexed using a linguistic specification. In addition, in order to generate the desired speech, suitable indexed speech samples can be selected and concatenated.

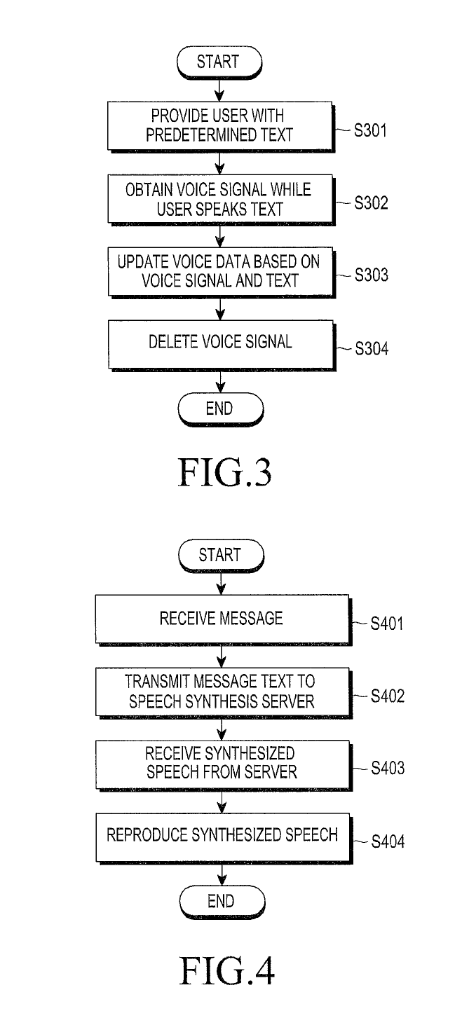

The voice data, which can for example be a statistical acoustic voice model or a plurality of recorded speech samples, can be obtained using various methods, examples of which will now be described with reference to FIGS. 2 and 3.

Referring to FIG. 2, a method of updating stored voice data according to an embodiment of the present disclosure is illustrated. Referring to FIG. 2, the method of updating stored voice data according to an embodiment of the present disclosure can use natural speech data acquired during phone conversations to build a voice model for an individual originator.

Referring to FIG. 2, in operation S201, a communication device can obtain a voice signal transmitted by an originator during a telephone conversation. Specifically, it is assumed that a voice signal transmitted from the phone number corresponding to the originator includes the originator's voice. In most countries there is a requirement to store voice communication in a specific server that manages voice data during a specific period of time, meaning that suitable voice signals for using embodiments of the present disclosure are already available without modifying the existing telephone network. Assuming that voice signals are not already stored, the communication device can be configured to connect to the telephone network that receives and records suitable voice signals, which can then be used to update the voice data.

For example, whenever a phone call is received from the originator at the end of the conversation, a message can be displayed at the recipient's communication device (for example, a smartphone or tablet computer) to ask if the originator's voice can be uploaded onto a server which manages the stored voice data. In other embodiments, uploading of the voice signal can be controlled by the originator whose voice signal is being recorded, by having their communication device record the voice signal being sent to the telephone network.

The voice data corresponding to that specific originator can be updated on a First In Last Out (FILO) basis, or in a random or periodic manner. New originators can be added to the communication device when a voice signal is uploaded for a contact number which is not already known to the communication device.

In operation S202, the communication device obtains a textual representation of speech included in the voice signal. Since in an embodiment of the present disclosure the voice signal includes natural speech recorded during a telephone conversation, an automatic speech recognition method can be used to transcribe the voice and obtain a textual representation of the voice signal.

In operation S203, the communication device updates the stored voice data using the voice signal and the obtained textual representation. For example, when the voice data is a statistical acoustic voice model, the model can be updated by using the voice signal to estimate new values of the parameters. The previous values can then be discarded.

In operation S204, the communication device deletes the voice signal.

Once the voice data has been updated, then in an embodiment of the present disclosure the voice signal can be deleted, as in operation S204. This is for the purpose of avoiding having to store actual recordings of voice conversations, which could lead to privacy concerns. However, in other embodiments the voice signal could be stored for future use.

Referring to FIG. 2, descriptions have been made in connection with updating the voice data for a single originator based on a voice signal obtained for that originator. However, a plurality of voice signals can be obtained for the same originator from a plurality of telephone conversations between the originator and one or more other originators. For example, a plurality of voice signals can be obtained by a server, which is configured to communicate with the communication device, for the same originator from a plurality of telephone conversations between the originator and one or more other originators. In addition, the operations of obtaining a textual representation and updating the stored voice data can be performed for each of the plurality of voice signals.

Referring to FIG. 3, a method of updating stored voice data according to another embodiment of the present disclosure is illustrated. Referring to FIG. 3, the method of updating stored voice data according to another embodiment of the present disclosure can be referred to as a “read speech” method, which uses read speech utterances of known phrases to build a voice model for an individual originator.

In operation S301, the originator can be provided with a predetermined text. For example, the text can be supplied in printed form to the originator, or a communication device can display the text on a screen. In operation S302, the communication device can record a voice signal while the originator speaks the predetermined text. In operation S303, the communication device can update the voice data using the voice signal and the predetermined text. In this embodiment, unlike the embodiment of FIG. 2, the communication device needs not perform ASR on the voice signal since the text being spoken is already known.

As in the above-described embodiment of FIG. 2, in other embodiments of the present disclosure, the voice signal can be retained, but after voice data stored according to the above-described operations are updated, the communication device can then delete the voice data in operation S304.

It has been described as an example that operations according to the above-described embodiments of FIG. 1 to FIG. 3 are respectively performed in a single device, for example a communication device (also referred to as a mobile communication device) such as a smartphone or tablet computer. However, the operations according to the above-described embodiments can also be divided between different apparatuses (e.g. communication device, server, and the like) and then performed. For example, the message can be received at a communication device which reproduces the synthesized speech, but the actual speech synthesis and voice data management operations can be performed remotely, for example by a server accessed over the Internet or another network.

Referring to FIG. 4, a method of performing remote speech synthesis at a server using text from a message received by a communication device is illustrated, according to an embodiment of the present disclosure.

First, in operation S401, a communication device can receive a message including text and sender identification information. For example, the communication device can be configured to communicate with a server that performs speech synthesis. For example, the communication device can connect to a mobile telecommunication network in order to access the server, or could use another suitable networking protocol such as WiFi or Bluetooth to access the Internet and connect to the server.

In operation S402, the communication device can send the text and originator identification information to the server. Here, the communication device can simply forward the received message to the server without modification, or can extract the text and originator identification information and strip out unnecessary data from the received message. For example, the received message (e.g. received email) can include inline images and/or attachments which are not suitable for speech synthesis, and the communication device can extract only the message text and originator identification information to be sent to the server. This can reduce the amount of data that has to be uploaded.

According to the above-described operation S402, the server can receive the originator identification information and text, retrieve the stored voice data corresponding to the originator identified by the originator identification information, and synthesize speech from the text and the stored voice data. In operation S403, the communication device can receive the synthesized speech from the server. Any suitable file format can be used for the synthesized speech. In operation S404, the communication device can reproduce the received synthesized speech through a speaker.

Although in an embodiment of the present disclosure the communication device forwards text and originator identification information to the server in operation S402, in some embodiments this operation can be omitted. For example, a mobile telecommunication network can be configured to automatically forward a SMS message to the server that synthesizes speech as well as to the intended recipient (e.g. specific communication device). The server that synthesizes speech can then notify the recipient of the SMS message that an audio reproduction of the SMS message is available, and transmit the synthesized speech to the message recipient upon request. Similar methods could also be applied to other types of communication networks and other text-based messages.

Although in the method according to embodiments of FIG. 4 the speech synthesis is performed on the network side by a server, it will be understood that in other embodiments the operations of retrieving the voice data and synthesizing the speech can be performed by the same communication device which received the message.

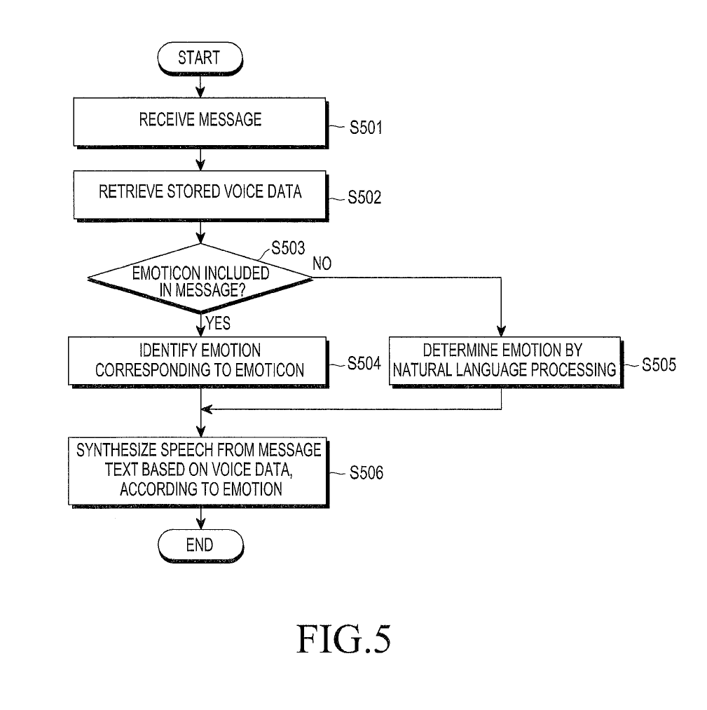

Referring now to FIG. 5, a method of detecting emotion from a received message and synthesizing speech according to the detected emotion is illustrated, according to an embodiment of the present disclosure.

In operation S501, a communication device can receive a message including text and originator identification information. In operation S502, the communication device can retrieve stored voice data corresponding to the originator identified by the originator identification information, for example from a local storage unit or by accessing a remote voice data server. Although in the present embodiment the voice data is retrieved before performing emotion detection, in other embodiments these operations can be performed in a different order. In general, the voice data can be retrieved at any point between receiving the message in operation S501 and synthesizing the speech in operation S506.

In operation S503, the communication device can check whether the received text includes an emoticon. Emoticons are well-known, and can include predetermined sequences of characters that are used to convey a particular emotion.

If an emoticon is detected, then in operation S504 the communication device can identify an emotion corresponding to the detected emoticon. For example, the communication device can send a query, which is for the purpose of confirming an emotion corresponding to the emoticon, to a database which stores known emoticons together with a corresponding emotion.

On the other hand, if no emoticon is detected, then in operation S505 the communication device can determine an emotion by analyzing the text using a natural language processing method. In this operation, the text can be analyzed for particular words and patterns that can indicate a particular emotion. For example, an emotion detected from the text “where are you, I am waiting for you” can be ‘anger’. The natural language processing method can, for example, be an artificial neural network-based method or a knowledge-based method.

Once the emotion has been determined according to the above-described operations, then in operation S506 the communication device can synthesize the speech according to the determined emotion. By adapting the speech synthesis according to the emotion, a more realistic and natural speech output conveying message with emotion can be provided. Therefore, a message recipient, who uses a communication device according to the embodiment of FIG. 5, can be made to hear a voice reproduction of the message text in the originator's voice and emotion, for example angry, happy, sad, and so on.

In other embodiments, the communication device can perform emotion detection using only one of the operations of FIG. 5, e.g. emoticon recognition or natural language processing. Also, in some embodiments, the communication device can use emoticon recognition and natural language processing operations together to perform emotion detection. For example, even when an emoticon is detected, natural language processing can still be used to check whether the emotion determined from the emoticon agrees with the emotion detected by natural language processing.

In some embodiments of the present disclosure, emotion detected can be omitted and speech can be synthesized only based on the retrieved voice data, without adapting the synthesized speech according to a particular emotion.

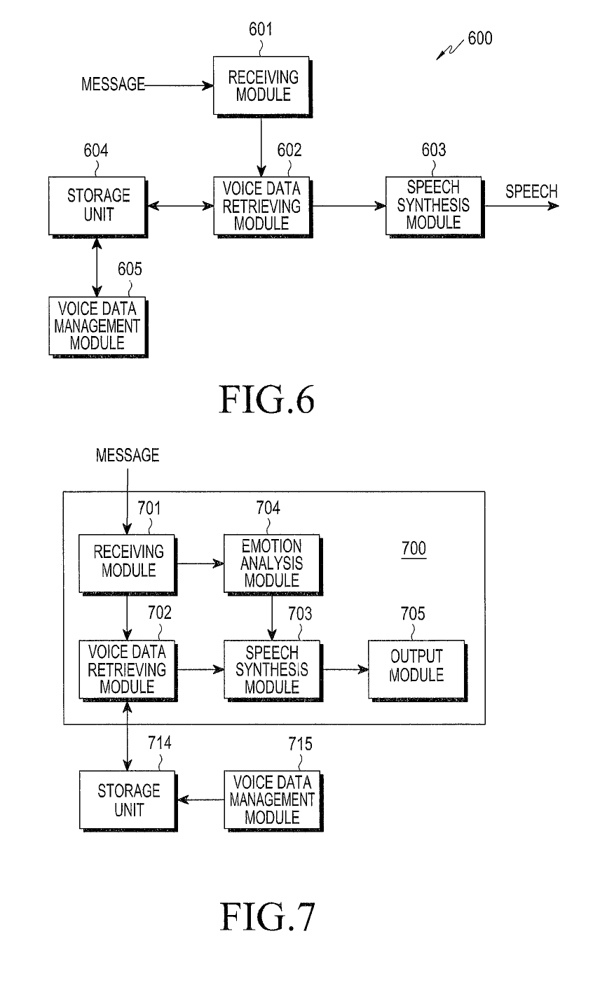

Referring to FIG. 6, a text-to-speech conversion apparatus (e.g. communication device; hereinafter, referred to as a communication device) according to an embodiment of the present disclosure is illustrated. The communication device can perform any of the operations of FIGS. 1 to 5, and certain modules shown in FIG. 6 can be implemented as software instructions which perform the appropriate operations when executed by a processor. In addition, the processor can control operations of some or all modules described later, according to the software instructions. For example, dedicated hardware such as an Application Specific Integrated Circuit (ASIC) can be provided to perform certain functions within the communication device.

As shown in FIG. 6, the communication device 600 can include a receiving module 601 configured to receive a message including text and originator identification information, a voice data retrieving module 602 configured to retrieve voice data corresponding to an originator identified by the originator identification information, from a storage unit 604, and a speech synthesis module 603 configured to synthesize speech from the text included in the message based on the retrieved voice data.

The communication device 600 can further include a voice data management module 605 configured to obtain a voice signal transmitted by the originator during a telephone conversation, obtain a textual representation of speech included in the voice signal, using an automatic speech recognition method, and update the stored voice data in the storage unit 604 using the voice signal and the obtained textual representation. The voice data management module 605 can be configured to obtain a plurality of voice signals from a plurality of telephone conversations between the originator and one or more other originators, and obtain a textual representation and update the stored voice data for each of the plurality of voice signals, using a method such as the one described above with reference to FIG. 2.

Instead of, or as well as obtaining voice signals from the telephone conversations, the originator can be provided with a predetermined text, and the voice data management module 605 can be configured to obtain a voice signal while the originator speaks the predetermined text, and update the stored voice data using the voice signal and the predetermined text, using a method such as the one described above with reference to FIG. 3.

The voice data management module 605 can delete the voice signals after updating the stored voice data.

Referring to FIG. 7, a communication device is configured to convert text in a received message into speech is illustrated, according to an embodiment of the present disclosure. The communication device 700 can include certain components of the system shown in FIG. 6, specifically a receiving module 701 (receiving module 601), a voice data retrieving module 702 (voice data retrieving module 602), and a speech synthesis module 703 (speech synthesis module 603). The communication device 700 can further include an emotion analysis module 704 and output module 705. The emotion analysis module 704 can determine an emotion from text included in the message, for example by using a method such as the one shown in FIG. 4. The output module 705 includes a speaker to reproduce the speech produced by the speech synthesis module 703. The output module 705 can also include a display to reproduce the text included in the received message.

In the present embodiment, the voice data retrieving module 702 can be configured to retrieve the voice data from a server (e.g. remote voice data server), which includes a storage unit 714 to store the voice data and a voice data management module 715 to generate and update the voice data. However, in other embodiments, the storage unit and/or voice data management module can be included within the communication device itself, so that voice data can be locally stored and/or updated within the communication device.

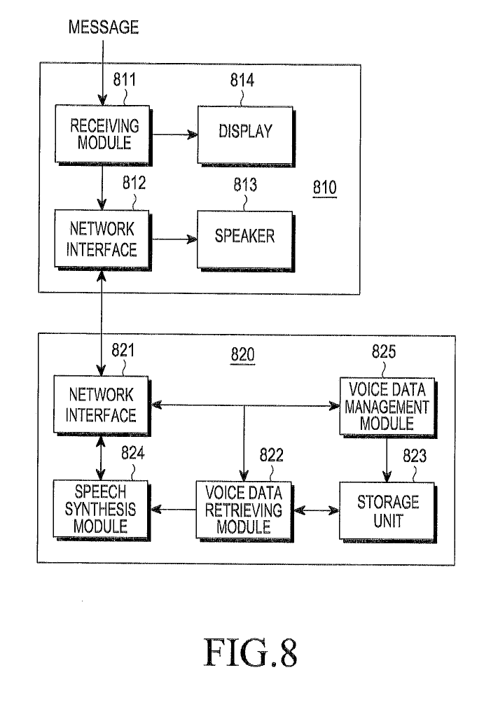

Referring to FIG. 8, a communication device configured to obtain synthesized speech from a server and a system including the server are illustrated, according to an embodiment of the present disclosure.

The communication device 810 can include a receiving module 811, a network interface 812, a speaker 813, or a display 814. The receiving module 811 can receive a message, and send text and originator identification information included in the message to a server 820 through the network interface 812. The text in the received message can be displayed on the display 814, and synthesized speech received from the server 820 through the network interface 812 can be reproduced through the speaker 813.

The server 820 can include its own network interface 821 for communicating with the communication device 810. The server 820 can further include a voice data retrieving module 822, a storage unit 823, a speech synthesis module 824, and a voice data management module 825. When text and originator identification information is received through the network interface 821, the voice data retrieving module 822 can retrieve voice data from the storage unit 823 and send the voice data to the speech synthesis module 824, which performs speech synthesis on the received text using the voice data.

In addition, the server 820 can also include an emotion analysis module, not shown in FIG. 8, similar to the one described above with reference to FIG. 7.

The voice data management module 825 can generate and update voice data stored in the storage unit 823, for example using a method such as the one shown in FIG. 2 or FIG. 3. In other embodiments, the functions of the server 820 can be divided amongst a plurality of servers. For example, separate voice data management servers and speech synthesis servers can be provided.

Embodiments of the present disclosure can enable a received message to be converted into speech in the voice of the originator who sent the message. This can enable a recipient to easily identify the originator of the message, and may also be used, for example, when the recipient is visually impaired, or when the recipient is driving and using a hands-free mode on a mobile telephone, and is unable to look at the screen. In addition, by including emotion in the synthesized speech, the message context may also be easily understood.

Various embodiments described herein may be implemented in a computer-readable medium using, for example, computer software, hardware, or some combination thereof. For example, the voice data retrieving module, the speech synthesis module, and/or the voice data management module can be implemented on hardware and/or software components.

For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, other electronic units designed to perform the functions described herein, or a selective combination thereof. The controllers can comprise any conventional control means such as relay technology, ASICs, FPGA, programmable micro-controllers and micro-processors.

For a software implementation, the embodiments described herein may be implemented with separate software modules, such as procedures and functions, each of which perform one or more of the functions and operations described herein. The software codes can be implemented with a software application written in any suitable programming language and may be stored in memory, and executed by a controller or processor.

The scope of the present invention is not limited to the embodiments disclosed in the present invention, but is defined by the claims and the equivalents thereof. Those skilled in the art will appreciate that various modifications, additions and substitutions are possible, without departing from the scope and spirit of the invention as disclosed in the accompanying claims.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A text-to-speech (TTS) conversion method comprising:
receiving a message including text and originator identification information;
retrieving stored voice data corresponding to an originator identified by the originator identification information; and
synthesizing speech from the text included in the message based on the retrieved voice data.

2. The method of claim 1, further comprising:
obtaining a first voice signal transmitted by the originator during a telephone conversation;
obtaining a textual representation of speech included in the first voice signal, using an automatic speech recognition method; and
updating the stored voice data using the first voice signal and the obtained textual representation.

3. The method of claim 2, wherein the method further comprises obtaining a plurality of first voice signals from a plurality of telephone conversations between the originator and one or more other originators and obtaining the textual representation, and
the updating the stored voice data is performed for each of the plurality of first voice signals.

4. The method of claim 1, further comprising:
providing the originator with a predetermined text;
obtaining a second voice signal while the originator speaks the predetermined text; and
updating the stored voice data using the second voice signal and the predetermined text.

5. The method of claim 4, further comprising:
deleting at least one voice signal of the first or second voice signal after updating the stored voice data.

6. The method of claim 1, wherein the voice data comprises a statistical acoustic model, and the speech is synthesized using a statistical parametric speech synthesis method.

7. The method of claim 1, further comprising:
determining an emotion from the text included in the message,
wherein the speech is synthesized according to the determined emotion.

8. The method of claim 7, wherein the emotion is determined by performing at least one of detecting an emoticon included in the text and identifying an emotion corresponding to the detected emoticon, or analysing the text using a natural language processing method.

9. The method of claim 1, wherein the originator identification information comprises at least one of a telephone number, an email address, or an originator name, and
the message comprises a Short Message Service (SMS) message, an email, an Instant Messaging (IM) message, or a Social Networking Service (SNS) message.

10. The method of claim 1, wherein the message is received by a communication device,
the speech synthesis is performed by a server configured to communicate with the communication device, the method further comprising:
receiving the synthesized speech from the server by the communication device; and
reproducing the synthesized speech by the communication device.

11. The method of claim 1, wherein the message is received by a communication device, and the retrieving the voice data and the synthesizing the speech are performed by the communication device.

12. A computer-readable storage medium configured to store a computer program that, when executed by one or more processors, causes the one or more processors to perform an operation of receiving a message including text and originator identification information, an operation of retrieving stored voice data corresponding to an originator identified by the originator identification information and an operation of synthesizing speech from the text included in the message based on the retrieved voice data.

13. A text-to-speech conversion apparatus comprising:
a receiving module configured to receive a message including a text and originator identification information;
a voice data retrieving module configured to retrieve voice data corresponding to an originator identified by the originator identification information, from a storage unit; and
a speech synthesis module configured to synthesize speech from the text included in the message based on the retrieved voice data.

14. The apparatus of claim 13, further comprising:
a voice data management module configured to:
obtain a first voice signal transmitted by the originator during a telephone conversation,
obtain a textual representation of speech included in the first voice signal, using an automatic speech recognition method, and
update the stored voice data using the first voice signal and the obtained textual representation.

15. The apparatus of claim 14, wherein the voice data management module is configured to obtain a plurality of first voice signals from a plurality of telephone conversations between the originator and one or more other originators, and obtain a textual representation and update the stored voice data for each of the plurality of first voice signals.

16. The apparatus of claim 13, wherein the originator is provided with predetermined text, and the voice data management module is configured to obtain a second voice signal while the originator speaks the predetermined text, and update the stored voice data using the second voice signal and the predetermined text.

17. The apparatus of claim 16, wherein the voice data management module is further configured to delete at least one of the first or second voice signal after updating the stored voice data.

18. The apparatus of claim 13, wherein the voice data comprises a statistical acoustic model, and the speech synthesis module is configured to synthesize the speech using a statistical parametric speech synthesis method.

19. The apparatus of claim 13, further comprising:
an emotion analysis module configured to determine an emotion from the text included in the message,
wherein the speech synthesis module is configured to synthesize the speech according to the determined emotion.

20. The apparatus of claim 19, wherein the emotion analysis module is configured to determine the emotion by performing at least one of detecting an emoticon included in the text and identifying an emotion corresponding to the detected emoticon, or analysing the text using a natural language processing method.

21. The apparatus of claim 13, wherein the originator identification information comprises at least one of a telephone number, an email address, or an originator name, and the message comprises a Short Message Service (SMS) message, an email, an Instant Messaging (IM) message, or a Social Networking Service (SNS) message.

22. The apparatus of claim 13, wherein the receiving module is included in a communication device, the speech synthesis module is included in a server, and the communication device is configured to communicate with the server, to receive the synthesized speech from the server, and to reproduce the synthesized speech.

23. The apparatus of claim 13, wherein the receiving module, the voice data retrieving module, and the speech synthesis module are included in a communication device.
